(19) United States
(12) Patent Application Publication
(10) Pub. No.: US 2019/0370942 A1
(43) Pub. Date: Dec. 5, 2019

(54) RED-EYE CORRECTION TECHNIQUES

(71) Applicant: Apple Inc., Cupertino, CA (US)

(72) Inventors: Alexis GATT, Cupertino, CA (US); David HAYWARD, Los Altos, CA (US); Emmanuel PIUZE-PHANEUF, Cupertino, CA (US); Mark ZIMMER, Cupertino, CA (US); Yingjun BAI, San Jose, CA (US); Zhigang FAN, Cupertino, CA (US)

(21) Appl. No.: 16/425,100

(22) Filed: May 29, 2019

Related U.S. Application Data
(60) Provisional application No. 62/679,399, filed on Jun. 1, 2018.

(51) Int. Cl. G06T 5/00; G06T 5/50; G06T 7/11; G06T 7/187; G06T 11/00; G06K 9/00; G06T 3/00; H04N 5/243

(52) U.S. Cl. CPC G06T 5/005; G06T 5/50; G06T 7/11; G06T 7/187; G06T 11/001; G06T 2207/30201; G06T 3/0068; H04N 5/243; G06T 2207/30216; G06T 2207/20156; G06K 9/0061

(57) ABSTRACT

Systems and methods are disclosed for correcting red-eye artifacts in a target image of a subject. Images, captured by a camera, including a raw image, are used to generate the target image. An eye region of the target image is modulated to correct for the red-eye artifacts, wherein correction is carried out based on information extracted from at least one of the raw image and the target image. Modulation comprises detecting landmarks associated with the eye region; estimating spectral response of the red eye artifacts; segmenting an image region of the eye based on the estimated spectral response of the red eye artifacts and the detected landmarks, forming a repair mask; and modifying an image region associated with the repair mask.

### CROSS REFERENCE TO RELATED APPLICATIONS

This application claims the benefit of U.S. Provisional Patent App. No. 62/679,399, filed Jun. 1, 2018, the disclosure of which is hereby incorporated by reference herein.

### BACKGROUND

Red-eye artifacts are prevalent in consumer photography, mainly due to the miniaturization of digital cameras. Mobile devices equipped with a camera, having the flash and the lenses in high proximity to each other, often cause a direct reflection of flash light from a subject's pupils to the camera's lenses. Due to this reflected light, the pupils captured by the camera appear unnatural, assuming various colors (from dark to brighter shades of red) as a function of the capturing conditions and the subject's intrinsic traits.

Correcting for red-eye artifacts typically involves first detecting (segmenting) the eye region containing the artifacts, and, then correcting the color of the respective pixels. Segmentation of the image region that had been distorted by the red-eye artifacts is commonly done by clustering the image pixels based on color, using a color space such as YCbCr or RGB, and/or by recognizing image patterns (e.g., the pupils' size and shape) by means of annular filters, for example. Once the image regions affected by the red-eye artifacts are identified, typically, the affected pixels are corrected by reducing their intensity (darkening). Many of the techniques that correct red-eye artifacts operate based on an already processed image in which the original appearance of the red-eye artifacts, due to the processing, is not preserved.

### BRIEF DESCRIPTION OF THE DRAWINGS

FIG. 1 is a diagram illustrating a configuration including a camera, a light source, and two subjects, positioned at different distances from the camera.

FIG. 2 is a diagram illustrating different red-eye artifacts.

FIG. 3 is a block diagram showing a camera system for red-eye artifact correction according to an aspect of the present disclosure.

FIG. 4 is diagram showing exemplary image processing algorithms according to an aspect of the present disclosure.

FIG. 5 is a functional block diagram illustrating a technique for red-eye artifact correction according to an aspect of the present disclosure.

FIG. 6 is a diagram illustrating intermediate processing results of a technique for red-eye artifact correction according to an aspect of the present disclosure.

### DETAILED DESCRIPTION

Aspects herein disclose systems and methods for correcting red-eye artifacts in a target image of a subject. In an aspect, one or more images, captured by a camera, may be received, including a raw image. The target image may be generated by the processing the captured images. Then, an eye region of the target image may be modulated to correct for the red-eye artifacts, wherein correction may be carried out based on information extracted from at least one of the raw image and the target image. In an aspect, modulation may comprise detecting landmarks associated with the eye region; estimating spectral response of the red eye artifacts; segmenting an image region of the eye based on the estimated spectral response of the red eye artifacts and the detected landmarks, forming a repair mask; and modifying an image region associated with the repair mask. In another aspect, modulation may comprise detecting landmarks associated with the eye region; estimating spectral response of a glint; segmenting an image region of the eye based on the estimated spectral response of the glint and the detected landmarks, forming a glint mask; and rendering one or more glints in a region associated with the glint mask. By leveraging both a raw image (or a pseudo-raw image) and a processed image, the accuracy of detecting affected regions, rendering the natural appearance of a subject's eyes, and restoring glints can be improved.

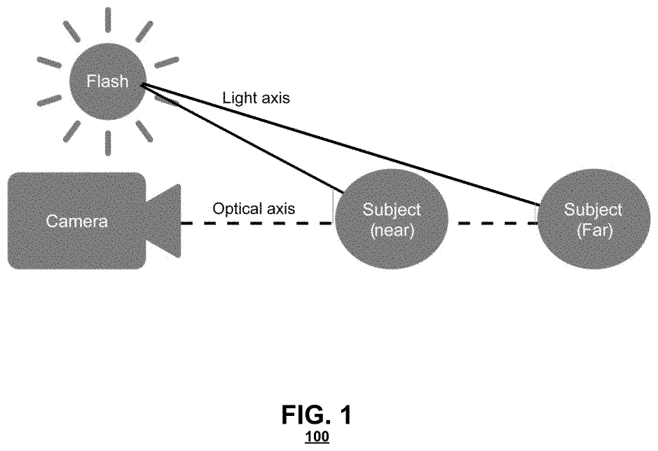

Red-eye artifacts are caused by light reflected from the pupil regions of a subject's eyes. Typically, red-eye artifacts are exacerbated when a subject is photographed in a dark environment with active camera flash. Light from the camera flash reaches the subject's pupils and is reflected back from the pupils to the camera's lenses. These reflections are captured by the camera's sensors and create the undesired image-artifacts. However, red-eye artifacts, despite their name, are not always red in color. The color of the light reflected from the subject's pupils and captured by the camera's sensors may vary based on the capturing conditions. As illustrated in FIG. 1, capturing conditions may include: the distance between the camera and the subject, the angle between the eye surface and the optical axis, and the intensity of the light source (flash). For example, at a short distance between the camera and the subject, red-eye artifacts may cause an eye reflection to appear in an amber or red color. While, at a long distance between the camera and the subject, an eye reflection may appear whiter. Thus, red-eye artifacts may be materialized within a spectrum of colors, depending, inter alia, on the capturing conditions.

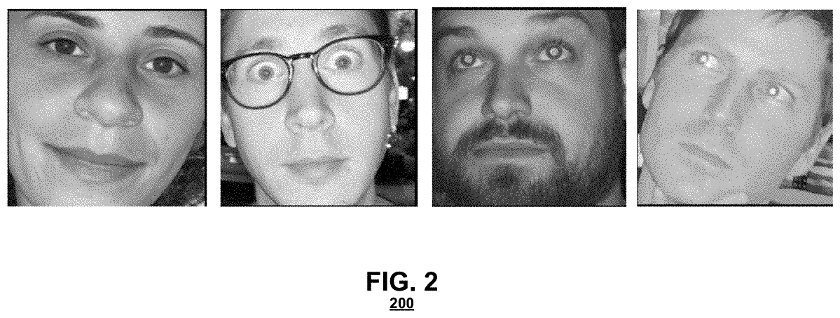

FIG. 2 illustrates the appearance of red-eye artifacts. Generally, red-eye artifacts may exhibit a range of colors, from pure white, through yellow, amber, bright red, maroon, to brown. As mentioned above, factors that may influence the color and pattern of the red-eye artifacts may be a function of the scene's conditions. For example, if the ambient light is very bright, such as outdoors at day time, the pupil will be fully constricted during capture and the resulting image will likely retain its normal color. However, some factors may be related to the subject herself—human genetics, medical condition, the presence of eyeglasses, or opaque and colorful contact lenses.

The camera system may also be an important factor in the appearance of the red-eye artifacts. The exposure time, aperture, and optical aberrations of the camera may be some of the factors affecting red-eye appearance. For example, the closer the flash is to the optical axis of the camera, the more directly the light will bounce off the eyes to the camera's lenses, and the “whiter” the red-eye artifacts may be. Likewise, processing operations such as tone curving, digital gain, white balancing, denoising, sharpening, histogram equalization, or alignment may cause further changes in the appearance (color and intensity) of the red-eye artifacts.

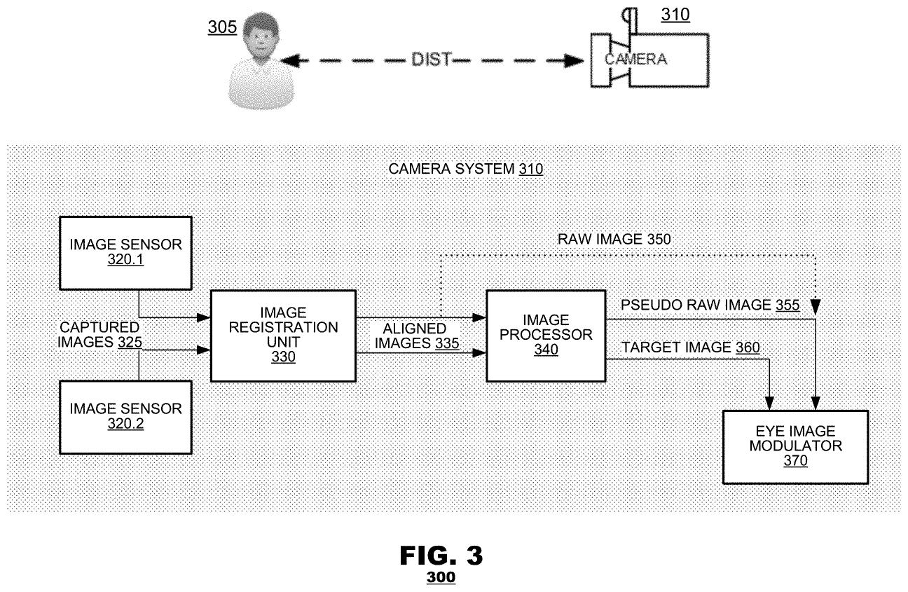

Aspects disclosed herein utilize raw images (or pseudo raw images) as well as processed images (target images) to correct red-eye artifacts and to restore glints. FIG. 3 illustrates a camera system 300 according to an aspect of the present disclosure. A camera system 310 may capture image data of a subject 305. The camera system 310 may have one or more image sensors, e.g., 320.1 and 320.2, an image registration unit 330, an image processor 340, and an eye image modulator 370. The sensors, 320.1 and 320.2, may capture images 325 of the subject 305. The camera system 310 may then align the captured images, employing image registration 330. The aligned images 335 may then be fed into an image processor 340 that may produce a target image 360. The image processor 340 may also produce a pseudo-raw image 355, employing different processing operations from those employed for the target image 360. The eye image modulator 370 may carry out the correction of the red-eye artifacts and may restore eye glints, receiving as inputs the raw image 350 (and/or the pseudo-raw image 355) and the target image 360.

In an aspect, one image 325 may be captured, from which the raw image 350 and the target image 360 may be derived. For example, a single image captured by a single image sensor 320.1 may be processed by the image processor 340 (bypassing the image registration unit 330) to form both a pseudo-raw image 355 and a target image 360. Both the pseudo-raw image 355 and its target image counterpart may then be used to carry out the eye image modulation 370. Alternatively, in addition or instead of the pseudo-raw image 355, the raw image 350 together with its target image counterpart may be used to carry out the eye image modulation 370.

In another aspect, two images 325 may be captured in temporal proximity to each other, from which the pseudo-raw image 355 and the target image 360 may be derived. For example, image sensor 320.1 may capture two images one after the other. Then, these two images may be aligned by the image registration unit 330. The two images may then be processed by the image processor 340 that may in turn generate the target image 360 and the pseudo-raw image 355. Both the pseudo-raw image 355 and its target image counterpart may then be used to carry out the eye image modulation 370. Alternatively, in addition or instead of the pseudo-raw image 355, the raw image 350 together with its target image counterpart may be used to carry out the eye image modulation 370. In an aspect, capturing settings of the two captured images 325 may differ from each other. For example, a camera flash may be enabled for one image (e.g., from which a target image may be generated) and may be disabled for the other image (e.g., from which a raw 350 or a pseudo-raw 355 image may be generated). Likewise, the exposure settings may vary from one image to the other.

In a further aspect, the images 325 may be captured by different image sensors. For example, a first image sensor 320.1 may be used to capture one or more images from which the raw 350 or pseudo-raw image 355 may be derived and a second image sensor 320.2 may be used to capture one or more images from which the target image 360 may be derived. Both the pseudo-raw image 355 and its target image counterpart 360 may then be used to carry out the eye image modulation 370. Alternatively, in addition or instead of the pseudo-raw image 355, the raw image 350 together with its target image counterpart 360 may be used to carry out the eye image modulation 370. Typically, the two image sensors, 320.1 and 320.2, may be positioned with a predetermined spatial relation to each other. During operation, the two image sensors, 320.1 and 320.2, may capture image information simultaneously or within temporal proximity. Capturing settings of these two sensors may be different from each other (such as exposure settings).

In cases where the images 325 are captured by different sensors, at different times, or both the images may be spatially misaligned due to vibrations of the camera system 310 or due to movements of the subject 305. To compensate for such misalignment, the images 325 may be spatially aligned to each other by the image registration unit 330, resulting in aligned images 335. The image registration unit may also account for distortions contributed by the camera's lenses (not shown). Furthermore, differences in color distributions across different sensors may also be accounted for by the image registration unit, by matching the colors of corresponding contents across images captured from different sensors 320 (e.g., employing color matching algorithms). Alignment of the captured images 325 may improve further processing disclosed herein, 340, 370. However, if only one image 325 is used and processed 340, image registration 330 may not be employed.

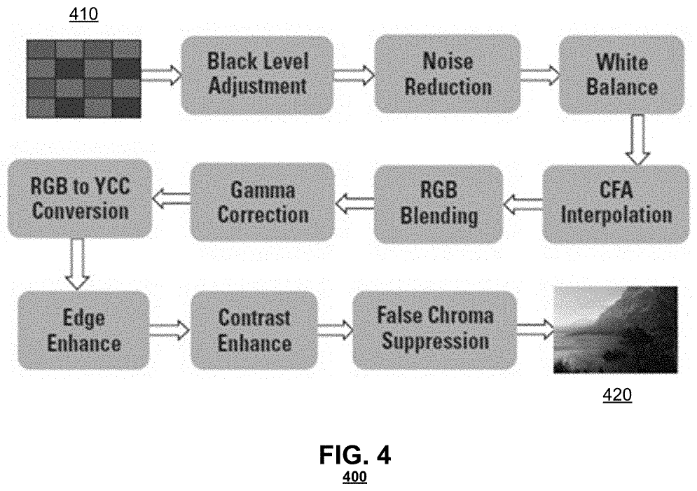

The image processor 340 may perform various operations of image enhancement. As illustrated in FIG. 4, the input image 410 (e.g., any of the aligned images 335 or if alignment may not be executed, any of the captured images 325) may be processed according to any one or a combination of algorithms such as: black level adjustment, noise reduction, white balance, RGB to YCC conversion (or any conversion between one color model to another), gamma correction, RGB blending (or any color model blending), Color Filter Array (CFA) interpolation (or color reconstruction), edge enhancement, contrast enhancement, or false chroma suppression. In an aspect, any of these algorithms, or other techniques that may correct for any undesired distortions or may otherwise prepare the image 410 for further processing may be employed. Any of these algorithms may be carried out consecutively or in parallel.

In an aspect, the image processor may generate two images—the pseudo-raw image 355 and the target image 360—based on the processing of one or more aligned images 335 or based on the processing of one or more of the captured images 325 (in case alignment is bypassed). Different algorithms may be used to generate the two images, 355 and 360. Alternatively, or in combination, the same algorithms may be used, but with different settings. Typically, the target image 360, the image that will be corrected and ultimately presented to the user, will be processed according to any settings of any combination of algorithms that may enhance its visual quality. However, the pseudo-raw image 355 may be processed differently so information that may be important for the characterization of the red-eye artifacts may not be compromised, as is explained in detail below.

In an aspect, the pseudo-raw image 355 may facilitate the correction operation of the target image 360. Therefore, in an aspect, any processing that may lead to loss of information ought to be avoided. Images 325 or 335 from which the pseudo-raw image 355 may be derived may be processed 340 in a constrained manner. For example, regions with red-eye artifacts tend to be near saturation; in such a case, processing that may result in a complete saturation may lead to a significant loss of information. Image regions affected by red-eye artifacts: when red, may be nearly saturated in the red channel (having a pixel RGB value of R˜255, G<255, and B<255), and when white, may be nearly saturated in all channels (having a pixel RGB value of R˜255, G˜255, and B˜255). Upon processing 340, slightly modifying these pixels beyond the [0, 255] range may cause them to be clipped to a value of 255, and, therefore, information that may have been carried by those pixels may not be restorable (lost).

In an aspect, processing of images 325 or 335 from which the pseudo-raw image 355 may be derived may vary based on the capturing conditions. Such variations may be a function of the physical properties of the sensors, the shutter, the analog gain, or the scene's configuration and lighting. Furthermore, algorithms employed by the image processor 340 to generate the pseudo-raw image 355 may be used with constrained parameter settings. For example, minimal noise reduction may be applied to prevent red pixels from the pupil to blend with similar red pixels that are external to the pupil image region. The white balance gain may be applied in a non-conventional manner—the gain per channel that is conventionally normalized according to WB=(WB_R, WB_G, WB_B)/MIN (WB_R, WB_G, WB_B) may be instead normalized according to WB=(WB_R, WB_G, WB_B)/MAX (WB_R, WB_G, WB_B), so that all pixel values may stay within the [0, 255] range and may not be clipped. Gamma correction may be applied using an inverse square root in order to prevent bright pixels from being clipped. Local tone mapping may not be applied. And, flat fielding or designating may be disabled to minimize the gain even further.

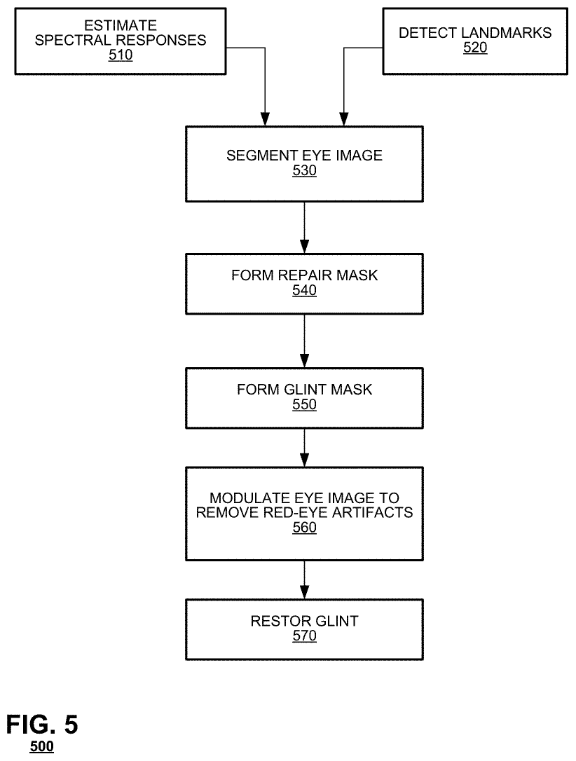

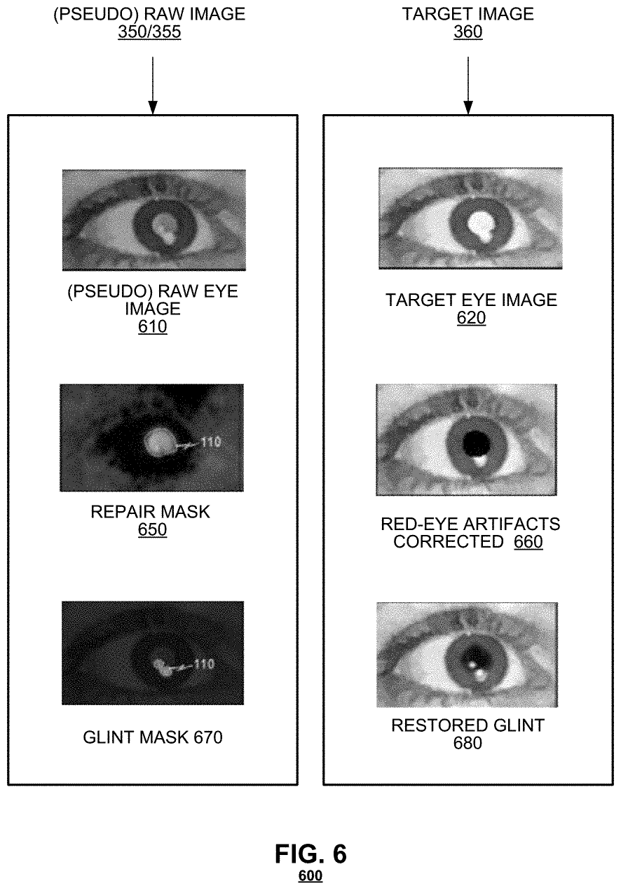

FIG. 5 is a functional block diagram 500 illustrating a method for correcting red-eye artifacts and restoring glints; method 500 may be employed by the eye image modulator 370, shown in FIG. 3. Exemplary intermediate processing results of correcting red-eye artifacts and restoring glints are illustrated in FIG. 6. The raw image 350 and/or the pseudo raw image 355 and the target image 360 may be available to method 500 to carry out the processing described below. As discussed, method 500 may use only the raw image 350 or only the pseudo raw image 355. Alternatively, method 500 may utilize both the pseudo raw image 355 and its respective raw image 350, as necessary.

In step 510, method 500 may estimate a red-eye spectral response and a glint spectral response based on ambient characteristics. For example, the red-eye spectral response may be estimated based on the distance between the subject and the camera or changes in light at the time of the image capturing, and/or based on any other factors related to the capturing conditions and the subject intrinsic traits.

In addition to estimating the spectral responses, in step 520, aspects of method 500 may search for landmarks, in both or either of the raw 350 (and/or 355) and the target 360 images, that may be used for recognition (detection) of the regions of the image that represent the eyes. The identified landmarks may be invariant facial features, such as geometrical features related to the lips, nose, and eyes. Features representing the eyes, for example, may include extremity points, the shape and pattern of the sclera, iris, and pupil. Facial landmarks that were previously used to guide alignment 330 may be used, at least as a starting point, in guiding the detection and extraction of eye related landmarks.

Regions of the eyes may be further analyzed and segmented in step 530, for example, to detect sub-regions that match the estimated spectral responses obtained in step 510. Hence, two segments may be extracted based on the spectral responses, one segment may correspond to the red-eye artifacts (the red-eye segment) and the other segment may correspond to the glint (the glint segment). In an aspect, the red-eye segment and/or the glint segment may be determined by region growing algorithms, starting from a center location (seed) in the respective segment and growing that seed outward as long as pixels within the growing regions are similar to (or within a pre-determined distance from) the respective spectral response. In an aspect, the seed used in the region growing algorithm may be a weighted centroid of a segment corresponding to the iris (the iris segment), as the iris is usually co-centric with the pupil. The iris segment may be derived based on a segmentation of the whole face. For example, segmentation of a low resolution version of the face image may be generated by a supervised classifier (e.g., neural network) trained on various classes (e.g., the nose, sclera, iris, and the rest of the face). Any other clustering or classification method may be used to cluster or classify image pixels as belonging to the red-eye segment or the glint segment based on their respective spectral responses or other discriminative features.

The red-eye segment may then be delineated in step 540 and may be represented by a repair mask 650, as illustrated in FIG. 6. Similarly, the glint segment may be delineated in step 550 and may be represented by a glint mask 670, as illustrated in FIG. 6. Notice that the red-eye segment and the glint segment may overlap each other. Therefore, as described, the operation of correcting the red-eye artifacts may be followed by the operation of restoring the glint.

The segmentation step 530 and the steps of forming the repair mask 540 and the glint mask 550 may be employed using any combination of the raw 350, the pseudo raw 355, and the target 360 images. However, using the pseudo-raw image (or the raw image) may be advantageous as red-eye and glint detection may be impaired when attempting detection using the target image. This is because the unconstrained image processing operations 340 employed on the target image may result in losses of image detail or changes in content in a way that makes the patterns of the red-eye artifacts and glints harder to detect.

Aspects disclosed herein may provide for red-eye modulation 370, wherein, in step 560, the red-eye artifacts may be corrected in regions of the target image that may be delineated by the repair mask 540. Furthermore, in an aspect, glints may be restored, in step 570, to the target image in regions that may be delineated by the glint mask 540. In a case where the repair and glint masks where formed with respect to the raw image 350 (or pseudo raw image 355), these masks may first be mapped from that image space 350 to the image space of the target image 360. However, this step may not be necessary if the two images, 350 and 360, are already aligned 330.

Red-eye artifacts modulation 560 may be employed using synthetic texturing. Synthesizing pupil image regions affected by the red-eye artifacts may be performed based on a texture. The texture may be based on statistics derived from unaffected eye image regions of the subject. Alternatively, a precomputed noise texture may be filtered by a low-pass filter with a mean that matches a reference color. The reference color may be a predetermined color of the pupil (e.g., estimated based on the colors of unaffected eye regions or based on other images of the same subject with no red-eye artifacts). A red-eye artifacts correction by modulation 370, according to an aspect disclosed herein, is demonstrated in 660 of FIG. 6.

Similarly, in step 570, synthesizing glints may be performed by rendering artificial glints. In an aspect, a glint may be restored by creating a radial disk (e.g., gaussian-like) that may be centered within the respective glint segment, as demonstrated in 680 of FIG. 6. Searching and identifying a glint pattern 530 may not be successful in all cases, as the spectral response of the red-eye artifacts may be close to the spectral response of the glint (e.g., when both are close to white). In such cases, effects resembling a glint may be rendered through alternative techniques that may not rely on the raw image 350 (or pseudo-raw image 355) content or the target image 360 content. For example, an estimate may be performed to identify a region of the eye that coincides with an optical axis that extends from the camera to the subject. Glint effects may then be superimposed on that region to mimic glint in the target image content. For example, a gaussian-like disk may be superimposed at that region.

In an aspect, validation steps may be integrated into method 500. Validation steps may be aimed at altering or aborting the process of correcting for red-eye artifacts when there may be a risk that non-pupil content may be affected, impairing the quality of the image. Accordingly, method 500 may integrate checks to determine whether such a risk may be present and, if so, operation of the method may be altered or aborted. For example, red-eye correction may be aborted based on a shape of the repair mask—if the repair mask has a concave or irregular shape, red-eye correction may be aborted, or, otherwise, an alternative approach to forming that mask may be taken (e.g., an alternative method of deriving the red-eye segment). Red-eye correction may also be aborted based on characteristics of a spectral response from which the repair mask is to be derived. For example, histograms of the spectral response may be analyzed to confirm that image data (extracted from the eye region) exhibit a strong peak response within the pupil and a flat response within non-pupil structures (e.g., the iris or the sclera). If a strong peak response within the pupil and a flat response within non-pupil structures are not exhibited, then method 500 may be aborted. Likewise, if the raw image 350 and/or the pseudo raw image 355 are found to be without sufficient quality (too blurry or distorted) method 500 may be aborted. For example, method 500 may include processes that may be indicative of the quality of the image (e.g., motion blur estimation) that may be used for the validation process.

In an aspect, other measures may be integrated into method 500 to aid in estimating the likelihood of a successful red-eye artifacts correction and glint restoration (or the risk of unsuccessful correction and restoration that may reduce image quality). For example, expected pupil sizes and glint sizes may be used by method 500, e.g., to assess validity of the segmentation 530. An expected pupil size may be estimated by weighting factors such as: the inter-pupillary distance (derived from the center of the eye landmarks), the bounding rectangle of the eye landmark, the triangle formed by the eyes' centers and the tip of the nose; and the 3D head pose estimate.

In an aspect, a decision to abort may be made at the outset based on geometry information. For example, the geometry of the left and right eyes' repair masks may be compared. If there is no sufficient similarly in shape and form, a decision to abort may be taken, as repair masks are expected to be rotationally and translationally similar. In an aspect, the face orientation and/or eye orientation may also be used by method 500 for validation. These orientations may be estimated based on the detected landmarks 520.

In an aspect, method 500 comprises the prediction of a glint's location and whether there is more than one glint. The glint location may be derived based on the weighted centroid of the glint mask for subjects close to the camera (large subjects). For subjects further away (small subjects), glints that are not well aligned may appear unnatural and the glint is therefore instead taken from the center of the eye landmark region. For red-eye artifacts that may range between amber and pure white (see FIG. 2), the entire pupil region may be corrected, so restoring a single glint that may be applied over the corrected region of the pupil may suffice. For red-eye artifacts that may range between bright red to maroon (see FIG. 2), the original glint may be present in the target image and may be maintained as is.

The foregoing discussion has described operations of the aspects of the present disclosure in the context of a camera system's components. Commonly, these components are provided as electronic devices. Camera system's components can be embodied in integrated circuits, such as application specific integrated circuits, field programmable gate arrays, and/or digital signal processors. Alternatively, they can be embodied in computer programs that execute on camera-imbedded devices, personal computers, notebook computers, tablet computers, smartphones, or computer servers. Such computer programs are typically stored in physical storage media such as electronic-based, magnetic-based storage devices, and/or optically-based storage devices, where they are read into a processor and executed. And, of course, these components may be provided as hybrid systems with distributed functionality across dedicated hardware components and programmed general-purpose processors, as desired.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A method for correcting red-eye artifacts in a target image of a subject, comprising:
receiving one or more images, captured by a camera, comprising a raw image;
processing the captured one or more images to generate the target image; and
modulating an eye region of the target image to correct for the red-eye artifacts based on information extracted from the raw image or based on information extracted from the raw image and the target image.

2. The method of claim 1, wherein the modulating comprises:
detecting landmarks associated with the eye region;
estimating spectral response of the red eye artifacts;
forming a repair mask by segmenting an image region of the eye based on the estimated spectral response of the red eye artifacts and the detected landmarks; and
modifying an image region associated with the repair mask.

3. The method of claim 2, wherein the repair mask is refined by employing region growing operation, comprising using a seed associated with one or more centroids of a nose segment, a sclera segment, an iris segment, a pupil segment, and a face segment.

4. The method of claim 2, wherein the modifying an image region comprises:
applying a texture to the image region.

5. The method of claim 4, wherein the texture has a mean that matches a reference color.

6. The method of claim 1, wherein the modulating comprises:
detecting landmarks associated with the eye region;
estimating spectral response of a glint;
segmenting an image region of the eye based on the estimated spectral response of the glint and the detected landmarks, forming a glint mask; and
rendering one or more glints in a region associated with the glint mask.

7. The method of claim 1, further comprising:
identifying an image region of the eye that coincides with an optical axis that extends from the camera to the subject; and
restoring a glint by superimposing a radial disk at a region associated with the identified image region.

8. The method of claim 1, wherein the processing is based on one or more of
black level adjustment, noise reduction, white balancing, color model conversion, gamma correction, blending, color filter array interpolation, edge enhancement, contrast enhancement, or false chroma suppression.

9. The method of claim 1, wherein the received images are captured by a plurality of sensors of the camera;

10. The method of claim 1, wherein the received images are captured at different times.

11. The method of claim 1, wherein the received images are captured based on different capturing settings.

12. The method of claim 1, further comprising:
registering the received images by employing one or more of spatial alignment or color matching;

13. The method of claim 1, wherein:
the processing generates a pseudo-raw image using constrained parameter settings; and
the modulating is based on information extracted from the pseudo-raw image.

14. The method of claim 13, wherein the constrained parameter settings are based on one or more of physical properties of the camera, comprising properties associated with a sensor, a shutter, or an analog gain.

15. The method of claim 13, wherein the constrained parameter settings are based on the capturing conditions of the camera.

16. The method of claim 1, further comprising:
determining a risk that the correcting of red-eye artifacts reduces the target image quality; and
if the risk is above a threshold, aborting or altering the correcting of red-eye artifacts.

17. A computer system, comprising:
at least one processor;
at least one memory comprising instructions configured to be executed by the at least one processor to perform a method comprising:
receiving one or more images, captured by a camera, comprising a raw image;
processing the one or more captured images to generate a target image; and
modulating an eye region of the target image to correct for the red-eye artifacts based on information extracted from the raw image or based on information extracted from the raw image and the target image.

18. The system of claim 17, wherein the modulating comprises:
detecting landmarks associated with the eye region;
estimating spectral response of the red eye artifacts;
segmenting an image region of the eye based on the estimated spectral response of the red eye artifacts and the detected landmarks, forming a repair mask; and
modifying an image region associated with the repair mask.

19. The system of claim 18, wherein the repair mask is refined by employing region growing operation, comprising using a seed associated with one or more centroids of a nose segment, a sclera segment, an iris segment, a pupil segment, and a face segment.

20. The system of claim 18, wherein the modifying an image region comprises:
applying a texture to the image region, comprising using a texture mean that matches a reference color.

21. The system of claim 17, wherein the modulating comprises:
detecting landmarks associated with the eye region;
estimating spectral response of a glint;
segmenting an image region of the eye based on the estimated spectral response of the glint and the detected landmarks, forming a glint mask, and
rendering one or more glints in a region associated with the glint mask.

22. The system of claim 17, wherein:
the processing generates a pseudo-raw image using constrained parameter settings; and
the modulating is based on information extracted from the pseudo-raw image.

23. The system of claim 22, wherein the constrained parameter settings are based on capturing conditions of the camera, physical properties of the camera, or a combination thereof.

24. A non-transitory computer-readable medium comprising instructions executable by at least one processor to perform a method, the method comprising:
receiving one or more images, captured by a camera, comprising a raw image;
processing the one or more captured images to generate a target image; and
modulating an eye region of the target image to correct for the red-eye artifacts, based on information extracted from the raw image or based on information extracted from the raw image and the target image.

25. The medium of claim 24, wherein the modulating comprises:
detecting landmarks associated with the eye region;
estimating spectral response of the red eye artifacts;
segmenting an image region of the eye based on the estimated spectral response of the red eye artifacts and the detected landmarks, forming a repair mask; and
modifying an image region associated with the repair mask.

26. The medium of claim 25, wherein the repair mask is refined by employing region growing operation, comprising using a seed associated with one or more centroids of a nose segment, a sclera segment, an iris segment, a pupil segment, and a face segment.

27. The medium of claim 25, wherein the modifying an image region comprises:
applying a texture to the image region, comprising using a texture mean that matches a reference color.

28. The medium of claim 24, wherein the modulating comprises:
detecting landmarks associated with the eye region;
estimating spectral response of a glint;
segmenting an image region of the eye based on the estimated spectral response of the glint and the detected landmarks, forming a glint mask; and
rendering one or more glints in a region associated with the glint mask.

29. The medium of claim 24, wherein:
the processing generates a pseudo-raw image using constrained parameter settings; and
the modulating is based on information extracted from the pseudo-raw image.

30. The medium of claim 29, wherein the constrained parameter settings are based on capturing conditions of the camera, physical properties of the camera, or a combination thereof.
